(19) United States
(12) Patent Application Publication
(10) Pub. No.: US 2006/0127090 A1
(43) Pub. Date: Jun. 15, 2006

(54) Apparatus and method for controlling gain of optical receiver in optical communication system

(75) Inventors: Ja-Won Seo, Suwon-si (KR); Joo-Chul Cho, Suwon-si (KR); Joong-Hee Lee, Seongnam-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/253,110

(22) Filed: Oct. 18, 2005

(30) Foreign Application Priority Data
Dec. 15, 2004 (KR) 2004-106186

(51) Int. Cl. H04J 14/00

(52) U.S. Cl. 398/66

(57) ABSTRACT

Disclosed is an apparatus and method for linearly controlling the output gain of an optical receiver in an optical communication system. The gain control apparatus includes: a light-receiving device for converting an input optical signal into a current signal and outputting the current signal; a signal detection means for outputting a voltage signal corresponding to intensity changes in the current signal; an attenuation-degree determination means for determining a degree of attenuation of an RF signal restored from the current signal based on the voltage signal; and an amplification unit for amplifying and outputting the restored RF signal. Therefore, a broadcasting signal can be stably provided since the gain of the optical receiver is linearly controlled, and the circuit configuration of the optical receiver can be simplified since the gain of the optical receiver is controlled by a circuit having a relatively simple configuration.

### CLAIM OF PRIORITY

This application claims to the benefit of an earlier application entitled “Apparatus And Method For Controlling Gain Of Optical Receiver In Optical Communication System,” filed in the Korean Intellectual Property Office on Dec. 15, 2004 and assigned Serial No. 2004-106186, the entire contents of which are incorporated herein by reference.

### BACKGROUND OF THE INVENTION

1. Field of the Invention

The present invention relates to an optical receiver used in an optical communication system, and more particularly to an apparatus and method for linearly controlling the output gain of an optical receiver.

2. Description of the Related Art

In general, an optical communication system is suitable for transmitting a large amount of data such as broadcasting signals. A representative optical communication system is a passive optical network (PON). The passive optical network includes an optical line terminal (OLT), a plurality of optical network terminations (ONTs), and an optical splitter interposed between the optical line terminal and the optical network terminations, thereby forming a tree-like distribution topology.

In the passive optical network, the optical line terminal (OLT) converts, for example, analog and/or digital broadcasting signals into optical signals of predetermined wavelengths, multiplexes, and transmits the optical signals to the optical splitter. The optical splitter splits and transmits the optical signals, which have been transmitted from the optical line terminal (OLT), to the optical network terminations (ONTs). Each of the optical network terminations (ONTs) photo-electrically converts a received optical signal into an analog and/or digital broadcasting signal, and transfers the analog and/or digital broadcasting signal to a set-top box or a computer apparatus for a relevant subscriber.

Generally, an optical receiver (i.e., a photo-electric converter) in the optical network termination (ONT) includes a gain control circuit, which detects the intensity of an optical signal received from the optical line terminal (OLT) and controls the gain of a photo-electrically converted output signal depending on the detected intensity of the optical signal, in order to control the output level of a photo-electrically converted optical signal to be stabilized.

FIG. 1 is a circuit diagram illustrating a configuration of a gain control apparatus included in an optical receiver of a conventional optical communication system. In particular, FIG. 1 shows a variable gain amplification circuit which measures the intensity of a received optical signal and controls the resistance values of feedback resistors R1 to R3 step by step. The apparatus shown in FIG. 1 is disclosed in U.S. Pat. No. 6,462,327, which will now be described briefly hereinafter.

The circuit shown in FIG. 1 includes a preamplifier 101 for converting a received optical signal into a voltage signal, a plurality of feedback resistors R1, R2 and R3, and a plurality of buffer amplifiers 105, 107 and 109. The feedback resistors R1, R2 and R3 are connected in parallel between an input node and an output node 103 in order to control the gain of the preamplifier 101 on step by step. The buffer amplifiers 105, 107 and 109 are connected between the feedback resistors R1, R2 and R3 and the output node 103 of the preamplifier 101, respectively, and are switched on/off depending on the predetermined control signals ‘ENABLE’.

As shown in FIG. 1, when the feedback resistors R1, R2 and R3 for controlling the gain of the preamplifier 101 are connected in parallel and the control signal is selectively applied to each of the buffer amplifiers 105, 107 and 109, the buffer amplifiers 105, 107 and 109 are selectively switched on/off, thereby changing a summarized resistance value of the feedback resistors R1, R2 and R3. Consequently, the output gain of the preamplifier 101 are controlled according to the resistance values of the feedback resistors R1, R2 and R3.

For example, when the control signals are applied to switch on only the buffer amplifiers 105 and 109 and the other buffer amplifier 107 is switched off, the gain of the preamplifier 101 is determined by the resistance values of the feedback resistors R1 and R3 connected in parallel to each other.

However, according to the gain control apparatus shown in FIG. 1, because its gain is controlled by using resistance values obtained by combinations of the multiple feedback resistors, the gain control is discretely achieved. That is, the steps of the gain control are determined in proportion to the number of feedback resistors. However, when the number of feedback resistors increases to subdivide the steps of the gain control, the number of preamplifiers and the size of a supplementary circuit used to generate control signals must also increase in proportion to the number of feedback resistors. As such, there are many restrictions in controlling the gain continuously (linearly) according to the intensity of an optical signal.

Also, in order to generate control signals applied to the buffer amplifiers in the gain control apparatus shown in FIG. 1, it is necessary to configure a separate circuit for detecting and processing the intensity of an input optical signal based on an output voltage of the preamplifier and to perform an on/off control for the buffer amplifiers depending on the result of the processing. However, in this case, since the circuit becomes complicated and a high degree of accuracy is required, there are difficulties in that a circuit for generating control signals in proportion to the number of steps for gain control must be additionally configured.

### SUMMARY OF THE INVENTION

Accordingly, the present invention has been made to solve the above-mentioned problems occurring in the prior art and provides additional advantages, by providing an apparatus and method for linearly controlling the gain of an optical receiver used in an optical communication system.

Another aspect of the present invention is to provide an apparatus and method for controlling the gain of an optical receiver of an optical communication system, which does not require a complicated circuit configuration.

In one embodiment, there is provided a gain control apparatus included in an optical receiver of an optical communication system which includes: a light-receiving device for converting an input optical signal into a current signal and outputting the current signal; a signal detection means for outputting a voltage signal corresponding to intensity changes in the current signal; an attenuation-degree determination means for determining a degree of attenuation of an RF signal restored from the current signal based on the voltage signal; and an amplification unit for amplifying and outputting the restored RF signal.

In another embodiment, there is provided a method for controlling a gain of an optical receiver included in an optical communication system which performs the steps of: converting an optical signal input to a light-receiving device into a current signal and outputting the current signal; outputting a voltage signal corresponding to intensity changes in the current signal; determining a degree of attenuation of an RF signal, which is restored from the current signal, based on the voltage signal; and attenuating a signal level of the RF signal depending on the determined degree of attenuation.

### BRIEF DESCRIPTION OF THE DRAWINGS

The above features and advantages of the present invention will be more apparent from the following detailed description taken in conjunction with the accompanying drawings, in which:

FIG. 1 is a circuit diagram illustrating a configuration of a gain control apparatus included in an optical receiver of a conventional optical communication system;

FIG. 2 is a block diagram illustrating a configuration of an Ethernet passive optical network (EPON) to which the present invention is applied;

FIG. 3 is a block diagram illustrating a configuration of an optical network termination in an optical communication system to which the present invention is applied;

FIG. 4 is a block diagram illustrating a configuration of a gain control apparatus included in an optical receiver of an optical communication system according to an embodiment of the present invention;

FIGS. 5A to 5D show waveforms for explaining an operation according to an embodiment of the present invention; and

FIGS. 6A to 6C are graphs for explaining a procedure of determining a degree of attenuation of a received optical signal according to an embodiment of the present invention.

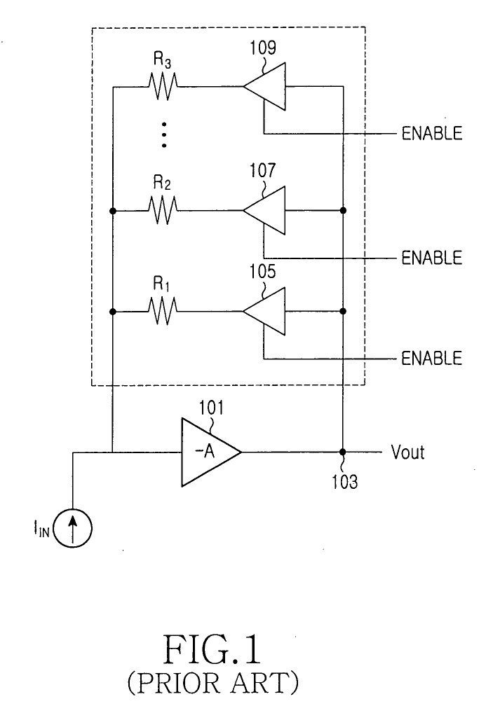

### DETAILED DESCRIPTION

Embodiments according to the present invention will be described with reference to the accompanying drawings. For the purposes of clarity and simplicity, a detailed description of known functions and configurations incorporated herein will be omitted as it may obscure the subject matter of the present invention.

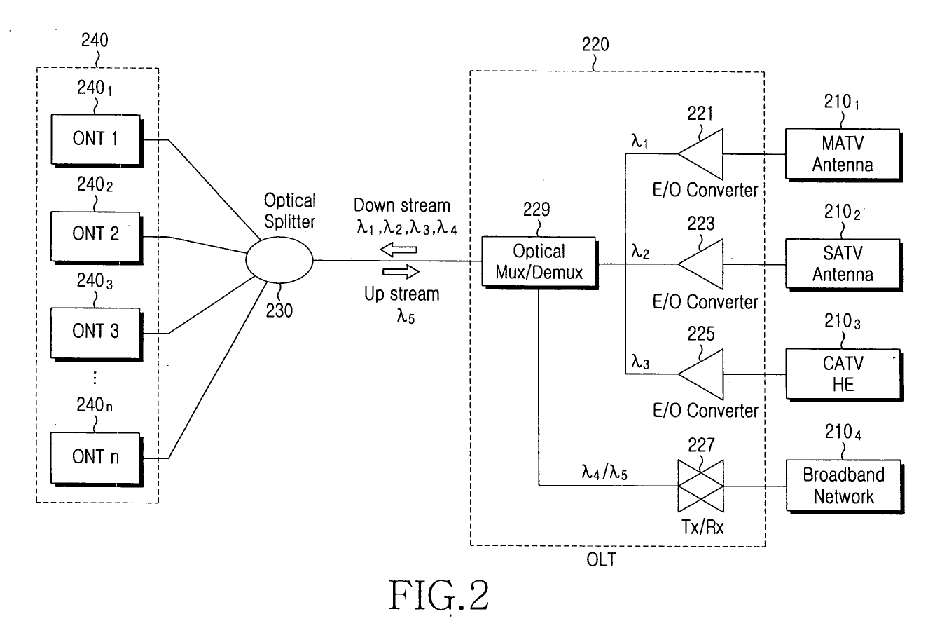

FIG. 2 is a block diagram illustrating a configuration of an Ethernet passive optical network, to which the apparatus and method of the present invention is applied.

As shown, the Ethernet passive optical network includes an optical line terminal (OLT) 220, an optical splitter 230, and a plurality of optical network terminations (ONTs) 240 (240₁ to 240ₙ). The optical line terminal 220 provides a triple play service capable of providing not only a bi-directional digital data service but also an analog image service in the EPON. The optical splitter 230 receives digital/analog data transmitted downward from the optical line terminal 220 and splits the received data into the multiple optical network terminations 240. The optical network terminations 240 receives digital/analog data split by the optical splitter 230 and transmits digital data upward to the optical line terminal 220.

Optical transmitters 221, 223, and 225 in the optical line terminal 220 receives analog broadcasting signals from various broadcasting signal supply sources 210₁ to 210₃, such as public broadcasting (MATV), satellite broadcasting (SATV), cable broadcasting (CATV), respectively. Then, the optical transmitters 221, 223, and 225 electro-optically converts the received broadcasting signals and transmits each of the photo-electrically converted signals to an optical multiplexer/demultiplexer 229 while carrying each converted signal on a distinct optical wavelength λ₁ to λ₃. The optical wavelength λ₁ to λ₃ changes depending on the design of whole system and the radio frequency (RF) range of the broadcasting signal.

A digital transceiver 227 in the optical line terminal 220 is connected to a broadband communication network 210₄, electro-optically converts a digital signal received from the broadband communication network 210₄, and transmits the photo-electrically converted signal to the optical multiplexer/demultiplexer 229 while carrying the photo-electrically converted signal on an optical wavelength λ₄. Also, the digital transceiver 227 photo-electrically converts an optical signal of an optical wavelength λ₅ received from the optical multiplexer/demultiplexer 229 and transmits the photo-electrically converted signal to the broadband communication network 210₄. The optical multiplexer/demultiplexer 229 multiplexes optical signals transmitted from the optical transmitters 221, 223, and 225 and an optical signal transmitted from the digital transceiver 227, then transmits the multiplexed signals downward to the optical splitter 230. Also, the optical multiplexer/demultiplexer 229 transmits uplink signals of the optical network terminations 240, which have received from the optical splitter 230, to the digital transceiver 227.

The optical splitter 230 receives multiplexed downlink signals from the optical line terminal 220, then splits the received downlink signals to the optical network terminations 240. Also, the optical splitter 230 multiplexes uplink signals transmitted from the multiple optical network terminations 240 and transmits the multiplexed uplink signals to the optical line terminal 220. The number of optical network terminations 240 connected to the optical line terminal 220 is determined based on the system operating scheme. Herein, each of the optical network terminations 240 includes an optical receiver for receiving and converting an optical signal into an electrical signal.

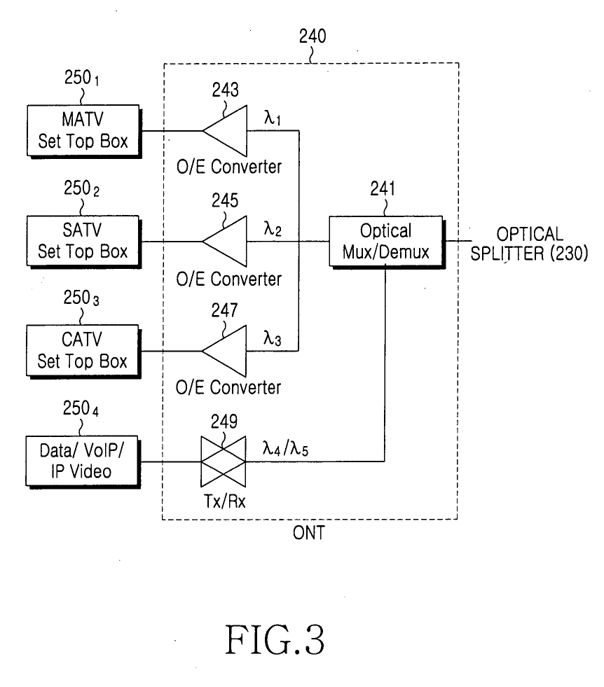

FIG. 3 is a block diagram illustrating a configuration of an optical network termination in an optical communication system according to an embodiment of the present invention.

In the optical network termination 240, an optical multiplexer/demultiplexer 241 multiplexes an optical signal to be transmitted upward and transmits the multiplexed optical signal to the optical splitter 230. Also, the optical multiplexer/demultiplexer 241 receives downlink-transmitted optical signals from the optical splitter 230, demultiplexes the received optical signals by a plurality of optical receivers 243, 245 and 247 according to predetermined wavelengths λ₁ to λ₄, respectively, then transmits the demultiplexed optical signals. Also, a digital signal from among downlink-transmitted optical signals from the optical splitter 230 is transmitted through the optical multiplexer/demultiplexer 241 to a digital transceiver 249.

Herein, each of the optical receivers 243, 245, and 247 and digital transceiver 249 includes a photo-electric converter for converting a received optical signal into an electrical signal. The photo-electrically converted analog/digital signals are transferred to set-top boxes 250₁ to 250₃, which receive broadcasting signals (such as public broadcasting signals, satellite broadcasting signals, and cable broadcasting signals), or a computer apparatus 250₄, thus are reproduced through a medium such as a TV receiving apparatus for a subscriber. Also, the digital transceiver 249 electro-optically converts a digital signal transmitted through a subscriber's computer apparatus or the like into an optical signal of a corresponding wavelength ‘λ₅’, and transmits the converted optical signal upward to the optical multiplexer/demultiplexer 241.

According to the configuration of the above-mentioned optical network termination, the multiple optical network terminations (ONT) 240 can receive and transfer a large amount of analog broadcasting signals or digital data according to the respective predetermined wavelengths to a subscriber's set-top box or computer apparatus. In this case, it is necessary for each of the multiple optical receivers 243, 245, and 247 and digital transceiver 249 to control its gain so as to stabilize its output level when a received optical signal is photo-electrically converted. To this end, the present invention provides a gain control apparatus capable of linearly controlling the gain of an optical receiver (and a digital transceiver).

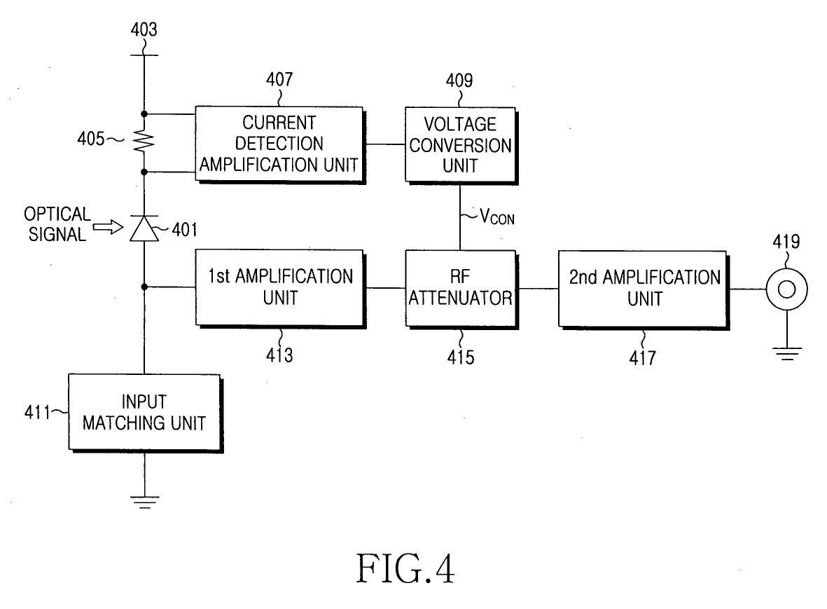

FIG. 4 is a block diagram illustrating a configuration of a gain control apparatus included in an optical receiver of an optical communication system according to an embodiment of the present invention. According to the teachings of the present invention, the gain control apparatus detects current changes in an optical signal received to a photodiode and then linearly controls the gain of an optical receiver using the result of the detection so that the output of the optical receiver may be adjusted to yield a constant level.

A photodiode 401 is driven by a DC biased power supply 403 and photo-electrically converts a received optical signal to output a current signal. A current detection resistor 405 is connected between the cathode of the photodiode 401 and the DC biased power supply 403 in order to detect the DC current output through the photodiode 401. A current detection amplification unit 407 is connected between both ends of the current detection resistor 405. The current detection amplification unit 407 amplifies a potential difference, which is generated by DC current flowing through the current detection resistor 405, by a predetermined gain, thereby outputting a first voltage signal.

Also, between the anode of the photodiode 401 and a ground terminal, an input matching unit 411 is connected to be matched with an interior amplification circuit. The input matching unit 411 restores current including a broadcasting signal, which is generated when the photodiode 401 receives an optical signal, to output an RF signal. The amplification circuit amplifies an RF signal converted photo-electrically through the photodiode 401 and the input matching unit 411, and includes a first and a second amplification units 413 and 417. Between the first and second amplification units 413 and 417, an RF attenuator 415 is connected to attenuate an RF signal, which is output from the first amplification unit 413 depending on the amount of current flowing through the photodiode 401, so as to maintain the RF signal at a predetermined level. The number of the amplification units and the RF attenuators may increase or decrease appropriately in consideration of a signal level.

Between the current detection amplification unit 407 and the RF attenuator 415, a voltage conversion unit 409 is connected to convert the voltage level of the first voltage signal output from the current detection amplification unit 407 into an input range of the RF attenuator 415 to output a second voltage signal. That is, in order to provide a stabilized broadcasting signal to a subscriber, the voltage level of an RF signal output from the second amplification unit 417 must be maintained at a predetermined level. To this end, it is necessary to calculate a degree of attenuation of the RF signal depending on the intensity of a received optical signal. After determining the degree of attenuation of the RF signal calculated based on the first voltage signal, the voltage conversion unit 409 converts the first voltage signal into a predetermined attenuation control voltage (hereinafter, referred to as a ‘second voltage signal’) corresponding to the determined degree of attenuation, then outputs the second voltage signal.

Therefore, an RF signal output from the first amplification unit 413 is output with its signal level attenuated by reflecting the degree of attenuation of the second voltage signal which is determined linearly depending on the amount of current flowing through the photodiode 401. The RF signal output from the RF attenuator 415 is again amplified by the second amplification unit 417, then output to a connector 419 for broadcasting signal output.

It should be noted that although the voltage conversion unit 409 for determining an attenuation control voltage is separately included in the above-mentioned configuration, the voltage conversion unit 409 may be integrally configured with the current detection amplification unit 407 or the RF attenuator 415. Also, although the RF attenuator 415 is connected between the first amplification unit 413 and the second amplification unit 417 in the above-mentioned configuration, the RF attenuator 415 may be connected to the front end or rear end of the first and second amplification units 413 and 417. In addition, although the current detection resistor 405 is used as a means for detecting the intensity of input optical signal according to an embodiment of the present invention, it should be noted that various passive/active devices capable of measuring the intensity of an input optical signal can be used as well as the current detection resistor 405.

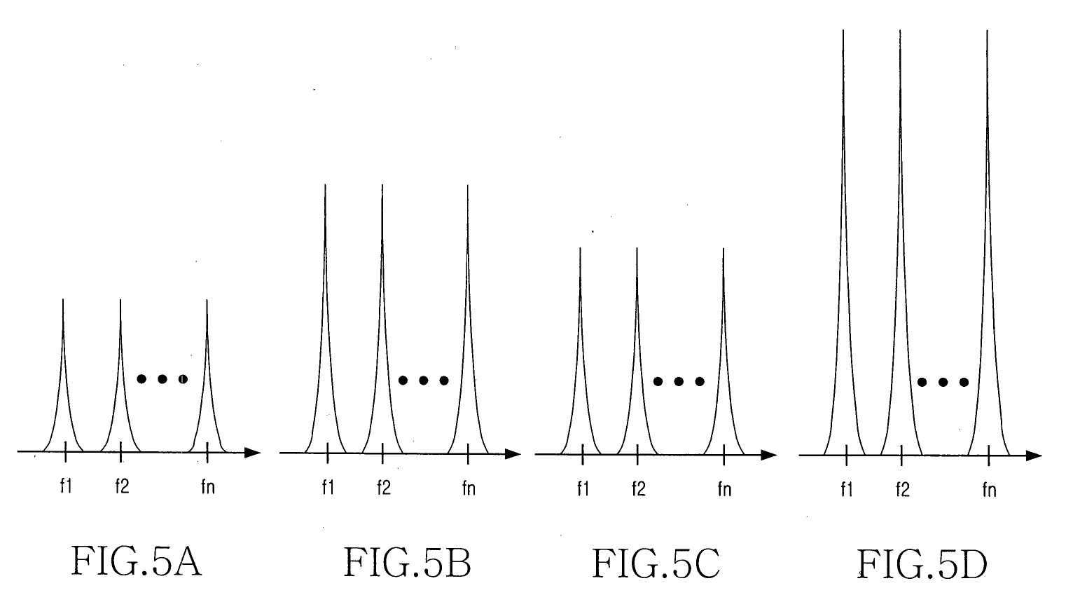

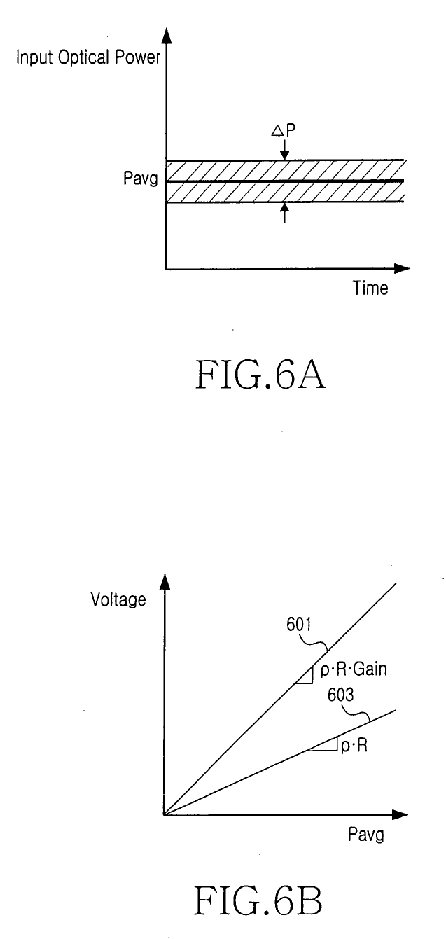

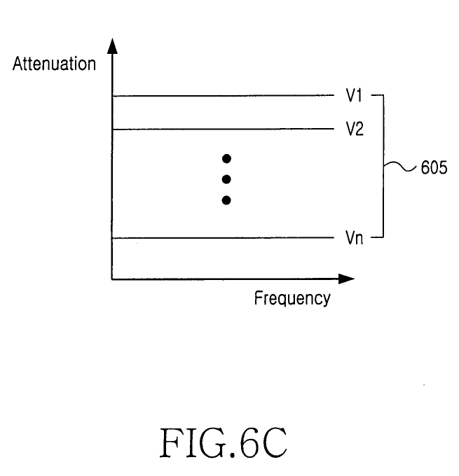

Hereinafter, the operation of the gain control apparatus shown in FIG. 4 will be described in detail with reference to FIGS. 5A and 6C.

Optical signals transmitted downward from the optical line terminal 220 are transmitted through the optical splitter 230 to the optical network termination 240 while being carried on different carriers ‘f1’, ‘f2’, . . . , ‘fn’ as shown in FIG. 5A. An optical signal received in an optical receiver of the optical network termination 240 is photo-electrically converted by the photodiode 401 of FIG. 4 and is output as a current signal. The input matching unit 411 restores current including a broadcasting signal, which is generated when the photodiode 401 receives an optical signal, thereby outputting an RF signal. Thereafter, the restored RF signal is amplified by a predetermined gain through the first amplification unit 413, and thus is output as shown in FIG. 5B.

Meanwhile, DC current flowing through the photodiode 401 of FIG. 4 is applied to the current detection resistor 405. The current detection amplification unit 407 amplifies a potential difference, which is generated by DC current flowing through the current detection resistor 405, by a predetermined gain, thereby outputting a first voltage signal. After the voltage conversion unit 409 determines a required degree of attenuation of an RF signal based on the first voltage signal, and then outputs a second voltage signal corresponding to the determined degree of attenuation to the RF attenuator 415. The RF attenuator 415 attenuates the RF signal, which is applied from the first amplification unit 413, by the degree of attenuation corresponding to the second voltage signal, and thus outputs an attenuated RF signal, for example, a signal shown in FIG. 5C. The attenuated RF signal is amplified as shown in FIG. 5D by the second amplification unit 417 and then is provided to a corresponding subscriber.

As described above, since the voltage between both ends of the current detection resistor 405 is proportional to the intensity of a received optical signal, when the degree of attenuation of an RF signal is determined based on the voltage between both ends of the current detection resistor 405, it is possible to maintain the signal level of a broadcasting signal at a predetermined level adaptively to the intensity of an input optical signal. Hereinafter, a procedure for determining a degree of linear attenuation of an RF signal according to an embodiment of the present invention will be described in detail.

When an input optical signal is modulated by ΔP about an average optical power of ‘Pavg’ as shown in FIG. 6A, the voltage between both ends of the current detection resistor 405 is determined by equation 1, thereby being proportional to the intensity of the input optical signal.
V=Pavg·ρ·R (1)

In equation 1, ‘ρ’ represents the responsivity [A/W] of the photodiode 401, and ‘R’ represents a resistance value of the current detection resistor 405.

FIG. 6B is a graph for illustrating a first voltage signal 601 having a predetermined gain ‘Gain’, which is obtained by amplifying the voltage 603 between both ends of the current detection resistor 405 by means of the current detection amplification unit 407. Herein, it should be noted that the first voltage signal 601 cannot be used directly as an attenuation control signal (second voltage signal) for the RF attenuator 415. That is, since the RF attenuator 415 has different degrees of attenuation depending on attenuation control voltages V1, V2, . . . , Vn 605 as shown in FIG. 6C, it is necessary to calculate a degree of attenuation required according to the intensity of a received optical signal and then to convert the first voltage signal into a second voltage signal corresponding to a calculated degree of attenuation, in order to maintain the RF signal output from the second amplification unit 417 at a predetermined level.

Therefore, according to an embodiment of the present invention, a voltage conversion circuit as shown as the voltage conversion unit 409 in FIG. 4 is provided. The current detection amplification unit 407 outputs a first voltage signal, which is obtained by amplifying the voltage between both ends of the current detection resistor 405 proportional to the intensity of an optical signal. Then, the voltage conversion unit 409 outputs a second voltage signal, which is determined depending on the degree of attenuation calculated based on an input first voltage signal within an attenuation control voltage range of V1 to Vn 605, thereby controlling the degree of attenuation of the RF attenuator 415. Consequently, according to an embodiment of the present invention, the gain of an optical receiver can be controlled linearly in proportion to the output of an input optical signal.

As described above, according to the gain control apparatus of the present invention, it is possible to linearly control the gain of an optical receiver in an optical communication system by controlling the degree of attenuation of the optical receiver in proportion to the intensity of an optical signal input to the optical receiver.

In addition, according to an embodiment of the present invention, a broadcasting signal can be stably provided since the gain of the optical receiver is linearly controlled, and the circuit configuration of the optical receiver can be simplified as the gain of the optical receiver is controlled by a circuit having a relatively simple configuration.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A gain control apparatus included in an optical receiver of an optical communication system, comprising:
a light-receiving device for converting an input optical signal into a current signal;
a signal detection means for outputting a voltage signal corresponding to intensity changes in the current signal;
an attenuation-degree determination means for determining a degree of attenuation of an RF signal restored from the current signal based on the voltage signal; and
an amplification unit for amplifying and outputting the restored RF signal.

2. The apparatus as claimed in claim 1, wherein the signal detection means comprises:
at least one resistance device coupled to one end of the light-receiving device; and
a current detection amplification unit for amplifying voltage between both ends of the resistance device, thereby outputting the voltage signal.

3. The apparatus as claimed in claim 2, wherein the attenuation-degree determination means comprises:
a voltage conversion unit for outputting a predetermined attenuation control voltage to determine the degree of attenuation of the RF signal based on the voltage signal; and
an RF attenuation unit for attenuating a signal level of the RF signal depending on the attenuation control voltage.

4. The apparatus as claimed in claim 1, wherein the gain control apparatus is contained in an optical receiver of an optical network termination which receives an analog signal.

5. The apparatus as claimed in claim 1, wherein the gain control apparatus is contained in a digital receiver of an optical network termination which receives a digital signal.

6. The apparatus as claimed in claim 1, wherein the optical communication system is a passive optical network.

7. The apparatus as claimed in claim 1, wherein the light-receiving device includes a photodiode.

8. A method for controlling a gain of an optical receiver included in an optical communication system, the method comprising the steps of:
converting an optical signal input to a light-receiving device into a current signal;
outputting a voltage signal corresponding to intensity changes in the current signal;
determining a degree of attenuation of an RF signal, which is restored from the current signal, based on the voltage signal; and
attenuating a signal level of the RF signal depending on the determined degree of attenuation.

9. The method as claimed in claim 8, wherein the voltage signal is obtained by using a potential difference between both ends of a predetermined resistance device through which the current signal flows.

10. The method as claimed in claim 8, wherein the gain control method is employed in an optical receiver of an optical network termination which receives an analog signal.

11. The method as claimed in claim 8, wherein the gain control method is employed in a digital receiver of an optical network termination which receives a digital signal.

12. The method as claimed in claim 8, wherein the optical communication system is a passive optical network.

13. An optical system having an optical line terminal (OLT), an optical splitter, and a plurality of optical network terminations (ONTs), wherein the ONTs further comprising an optical receiver including: a light-receiving device for converting an input optical signal into a current signal; a signal detection means for outputting a voltage signal corresponding to intensity changes in the current signal; an attenuation-degree determination means for determining a degree of attenuation of an RF signal restored from the current signal based on the voltage signal; and an amplification unit for amplifying and outputting the restored RF signal.

14. The system as claimed in claim 13, wherein the signal detection means comprises:
at least one resistance device coupled to one end of the light-receiving device; and
a current detection amplification unit for amplifying voltage between both ends of the resistance device, thereby outputting the voltage signal.

15. The system as claimed in claim 14, wherein the attenuation-degree determination means comprises:
a voltage conversion unit for outputting a predetermined attenuation control voltage to determine the degree of attenuation of the RF signal based on the voltage signal; and
an RF attenuation unit for attenuating a signal level of the RF signal depending on the attenuation control voltage.

16. The system as claimed in claim 13, wherein the gain control apparatus is contained in an optical receiver of an optical network termination which receives an analog signal.

17. The system as claimed in claim 13, wherein the gain control apparatus is contained in a digital receiver of an optical network termination which receives a digital signal.

18. The system as claimed in claim 13, wherein the optical communication system is a passive optical network.

19. The system as claimed in claim 13, wherein the light-receiving device includes a photodiode.
